(19) United States
(12) Patent Application Publication
(10) Pub. No.: US 2015/0142528 A1
(43) Pub. Date: May 21, 2015

(54) METHOD AND SYSTEM FOR OFFER BASED RATING

(71) Applicant: Paul M. Nelson, San Diego, CA (US)

(72) Inventor: Paul M. Nelson, San Diego, CA (US)

(21) Appl. No.: 14/085,741

(22) Filed: Nov. 20, 2013

(51) Int. Cl. G06Q 10/06

(52) U.S. Cl. CPC G06Q 10/0639
USPC 705/7.38

(57) ABSTRACT

An apparatus for generating prospect rating is described. The apparatus includes a non-transitory storage medium and a processor configured to execute codes stored on the non-transitory storage medium to perform the steps of: determine one or more offers that have been extended to a prospect, determine a relative value for each of the one or more offers based on an organization associated with the offer, add relative values of each of the one or more offers extended to the prospect to generate a prospect offer points score, and store, in a storage device, prospect offer points scores associated with a plurality of prospects.

### BACKGROUND OF THE INVENTION

1. Field of the Invention

The present invention relates generally to systems and methods for rating and ranking, and more specifically to systems and methods for rating and ranking prospects recruited by organizations based on offers received by the prospects.

2. Discussion of the Related Art

The success of an organization is often tied to the quality of the new recruits. For example, in college football, fans pay a lot of attention to which high school athletes have been offered scholarships by their favorite college teams. The ranking of the high school athletes is also highly watched by the fans.

Conventionally, the rankings of high school football players are determined by the staff of sports reporting services, which consist mostly of reporters and writers who specialize in college football reporting. As such, such rankings represent little more than the opinions of a select few sports writers, and are often regarded as being biased.

### SUMMARY OF THE INVENTION

Several embodiments of the invention advantageously address the needs above as well as other needs by providing an offer-based ranking for prospects being recruited into organizations.

In one embodiment, the invention can be characterized as an apparatus for generating prospect rating. The apparatus includes a non-transitory storage medium and a processor configured to execute codes stored on the non-transitory storage medium to determine one or more offers that have been extended to a prospect, determine a relative value for each of the one or more offers based on an organization associated with the offer, add relative values of each of the one or more offers extended to the prospect to generate a prospect offer points score, and store, in a storage device, prospect offer points scores associated with a plurality of prospects.

In another embodiment, the invention can be characterized as a computer-implemented method for generating prospect rating. The method includes the steps of: determining one or more offers that have been extended to a prospect, determining a relative value for each of the one or more offers based on an organization associated with the offer, adding relative values of each of the one or more offers extended to the prospect to generate a prospect offer points score, and storing, in a non-transitory computer readable medium, prospect offer points scores associated with a plurality of prospects.

In yet another embodiment, the invention can be characterized as a computer-implemented method for generating prospect rating, including the steps of: retrieving from one or more databases, information on a plurality of offers, each of the plurality of offers being made from an organization to a prospect, for a plurality of prospects, retrieving from a look-up table, the relative value for one or more offers extended to each of the plurality of prospects, wherein the relative value of an offer is based on a past success of an organization extending the offer, and adding, with a computer processor, relative values of the one or more offers extended to a prospect to generate a prospect offer points score, and storing, in a non-transitory computer readable medium, prospect offer points scores associated with a plurality of prospects. Wherein, the relative value for an offer extended by an organization is based on a weighted average of Elo scores of the organization's performance from two or more prior years.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a system for rating and ranking prospects according to one or more embodiments of the present invention.

FIG. 2 is a block diagram of the system for rating and ranking prospects including modules for system implementation, according to one or more embodiments of the present invention.

FIG. 3 is a flow diagram of a method for rating and ranking prospects according to one or more embodiments of the present invention.

FIG. 4 is a display screen of an example prospect ranking according to one or more embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Present disclosure describes a method for rating recruited prospects based on the offers they received from recruiting entities. Data on actual offers extended reflects the opinions of the coaching staffs of the recruiting organizations such as college teams, and their paid advisors. Offer based ranking, therefore, provides a more transparent rating and ranking system that is based on decisions made by experts on evaluating talent.

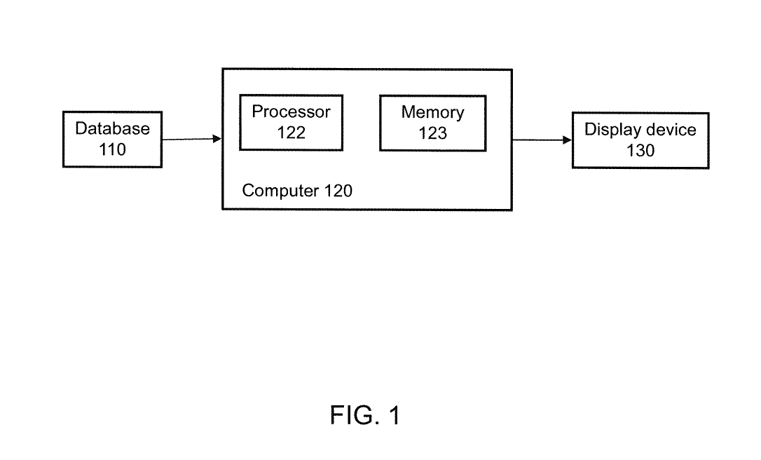

Referring first to FIG. 1, a system for determining an offer-based rating for prospects according to some embodiments is shown. The system includes a database 110, a computer 120, and a display device 130. The computer 120 may further include a processor 122 and a memory 123.

The database 110 may be internal, external, networked, and/or remote from the computer 120. While only one database is shown, it is understood that the computer 120 may be connected and configured to retrieve information from multiple databases. In some embodiments, the database 110 includes information available on the Internet, and the computer 120 retrieves the relevant information by parsing the information retrieved from the Internet. For example, the database may include one or more sports reporting service such as Rivals and ESPN which reports offers schools made to prospects and/or offers that have been accepted by the prospects.

In some embodiments, the computer 120 retrieves the information from the database 110 and stores it on memory 123 for later use. In some embodiments, the computer 120 periodically updates the information on its memory 123 with the information stored on the database 110.

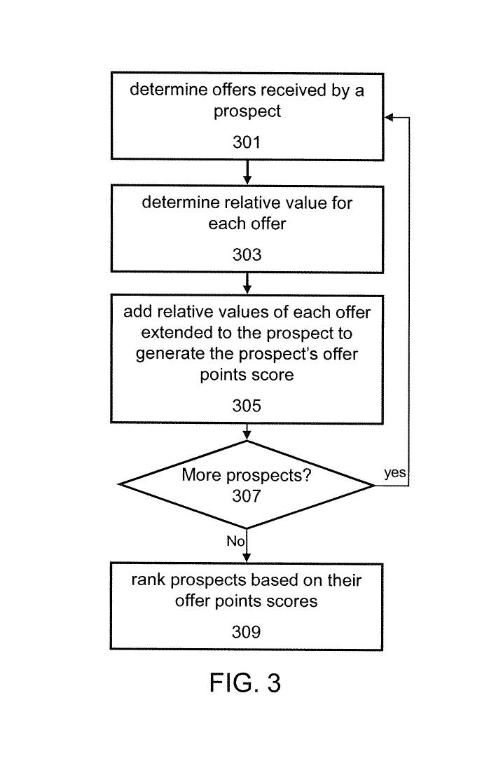

The computer 120 may be any processor based device such as a personal computer, a server, a mobile device etc. In some embodiments, the process of rating and ranking prospects as described with reference to FIG. 3 below may be performed by the processor 122 executing a set of computer codes stored in the memory 123. Memory 123 may be hard drive memory, RAM, ROM or a combination thereof. The memory 123 may store data relating to one or more offers made by schools, biographical data of prospects, relative values associated with schools, offer points scores of prospects, schools, and origin entities, and rankings of prospects and school. In some embodiments, each of these items of data may be stored on one or more computer readable memory that is internal, external, networked, and remote to the computer. In some embodiments, some of these data may be stored on a remote database and retrieved as needed.

It is understood that, while only one computer 120 is shown in FIG. 1, the process described with reference to FIG. 3 may be executed on two or more processor-based devices. For example, one processor-based device may perform step 301 and a separate processor-based device may perform step 305.

The display device 130 may be any known display device such as LCD, LED, OLED, etc. The display device 130 may be integrated, local, networked, and/or remote to the computer 120. In some embodiments, the display device 130 is coupled to a processor-based device separate from the computer 120. In some embodiments, at least one of the steps in the method described with reference to FIG. 3 is carried out on a processor-based device coupled to the display device. The display device 130 may further be coupled to a user input device that allows a user to interact with the rating and/or ranking displayed on the display device. For example, the user may filter, sort, or search through the displayed offer-based ranking using the user input device. The user may further select between viewing offer points scores of prospects, colleges, high schools, etc. The user may also select between viewing offer points scores and/or rankings of prospects from different school years.

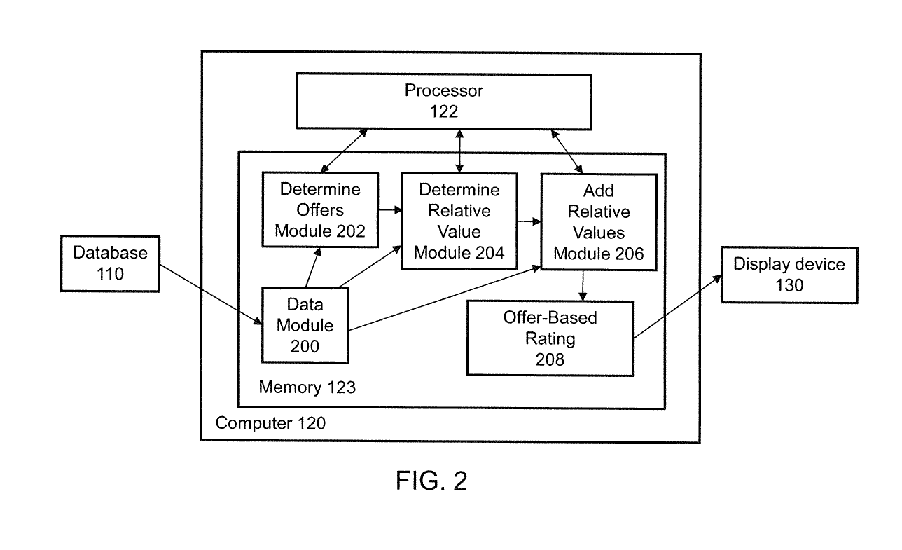

Referring next to FIG. 2, the system for determining the offer-based rating for prospects according to some embodiments is shown. Shown are the database 110, the computer 120, the processor 122, the memory 123, the display device 130, a data module 200, a determine offers module 202, a determine relative value module 204, an add relative values module 206, and an offer-based rating 208.

As previously shown in FIG. 1, the computer 120 includes the processor 122 and the memory 123. In the embodiment shown, the memory 123 further includes the data module 200, the determine offers module 202, the determine relative value module 204, the add relative values module 206, and the offer-based rating 208.

The data module 200 is communicatively coupled to the database 100, and receives the data from the database 110, as indicated by an arrow pointing from the database 110 to the data module 200. The data module 200 may comprise hard drive memory, RAM, ROM, a combination thereof, or any other type of memory suitable for storing the data and transferring the data as required to implement the system for determining the offer-based rating for prospects.

In one embodiment, the data module 200 is communicatively coupled to the determine offers module 202, the determine relative value module 204, and the add relative values module 206. The data module 200 transfers the data to the modules 202, 204, 206 as requested by the respective modules 202, 204, 206, as indicated by arrows pointing from the data module 200 to each of the modules 202, 204, 206.

The determine offers module 202 comprises computer programming language or other means suitable for performing an evaluation described below in step 301 of FIG. 3. The determine offers module 202 is communicatively coupled to the data module 200 (as previously described), the processor 112, and the determine relative value module 204. The determine offers module 202 includes hardware or software components, for example, computer programs or RAM, suitable for implementing a step 301 for determining offers received by a prospect as described below in FIG. 3 using the data transferred from the data module 200.

The determine offers module 202 is communicatively coupled to the processor 122 for both sending and receiving, as shown by a double-ended arrow between the evaluation module 202 and the processor 122.

The determine offers module 202 transfers a plurality of player offers, as described below in FIG. 3, to the determine relative value module 204, as shown by an arrow pointing from the determine offers module 202 to the determine relative value module 204.

The determine relative value module 204 comprises computer programming language or other means suitable for performing an evaluation described below in step 303. The determine relative value module 204 is communicatively coupled to the processor 122 for both sending and receiving, as shown by a double-ended arrow between the determine relative value module 204 and the processor 122.

The determine relative value module 204 transfers a plurality of player offer relative values, as described below in FIG. 3, to the add relative values module 206, as shown by an arrow pointing from the determine relative value module 204, to the add relative values module 206.

The add relative values module 206 comprises computer programming language or other means suitable for performing an evaluation described below in steps 305, 307, 309. The add relative values module 206 is communicatively coupled to the processor 122 for both sending and receiving, as shown by a double-ended arrow between the determine relative value module 204 and the processor 122.

The add relative values module 206 transfers an offer-based rating table, shown below in FIG. 2 in one embodiment of the invention, to the offer-based rating 208, as shown by an arrow pointing from the determine relative value module 204 to the add relative values module 206.

The offer-based rating 208 may comprise hard drive memory, RAM, ROM, a combination thereof, or any other type of memory suitable for storing and transferring data as required to implement the system for determining the offer-based rating for prospects.

The offer-based rating 208 is communicatively coupled to the display screen 130 for transferring the offer-based rating table to the display screen 130, as shown by an arrow pointing from the offer-based rating 208 to the display device 130.

Referring again to FIG. 2, the system shown includes components for evaluating the data according to the method described below in FIG. 3, and outputting the evaluation results to the display device 103.

The data module 200 included in the memory 123 receives the data from the database 110 as previously described in FIG. 1. The data module 200 then transfers data to modules 202, 204, 206 as required for the modules 202, 204, 206 to implement the method steps as shown below in FIG. 3. It should be noted that in some embodiments of the invention, modules 204, 206 may not require data from the data module 200.

The determine offers module 202, in conjunction with the processor 122, determines the plurality of player offers, as described below in step 301 of FIG. 3., and stores the resulting player offers for use by the determine relative value module 204.

The determine relative value module 204, in conjunction with the processor 122, utilizes the plurality of player offers, and in some embodiments additional data retrieved from the data module 200, to determine a plurality of relative offer values, as shown below in step 303 of FIG. 3. The determine relative value module 204 stores the plurality of relative offer values for use by the add relative values module 206.

The add relative values module 206, in conjunction with the processor 122, utilizes the plurality of relative offer values, and in some embodiments data retrieved from the data module 200, to add the relative offer values for each player and store a offer-based rating table, as described below in steps 105, 107, and 109 of FIG. 3.

The offer-based rating table 208 retrieves the offer-based rating table from the add relative values module 206. The offer-based rating table may then be transferred to the display device 130 for display. It should be noted that in some embodiments the offer-based rating 208 may be eliminated and the offer-based rating table transferred directly from the add relative values module to the display screen 130.

Referring next to FIG. 3, a method for rating and ranking prospects according to some embodiments is shown. In step 301, one or more offers received by a prospect are determined. An offer may refer to an invitation from a recruiting entity to a prospect. For example, in college football, offers may refer to scholarship offers extended by colleges to a high school football player. While “school” is used to refer to the recruiting entity in the descriptions herein, the recruiting entity may generally be any organization including sports and academic teams, clubs, etc. Prospects may be any skilled persons whom organizations may compete to recruit. For example, prospects may refer to players, athletes, students, doctors, lawyers, actors, engineers, computer programmers, other professional and semi-professionals in various fields, etc. In some embodiments, a prospect may be an athlete in basketball, football, baseball, soccer, rugby, lacrosse, tennis, swimming, track, or other sports.

In step 301, information on offers received by prospects can be retrieved from the internal or external database. In some embodiments, the offer information is retrieved from multiple external reporting services. Data from multiple sources may be compared and compiled to generate a more complete list of offers extended to prospects. For example, for offers made by Division 1 FBS colleges to high school football players, offer data may be obtained from Rivals and ESPN reporting services. The information on the two services are compared and combined to determine which schools have made offers to which high school football players.

In step 303, the relative value of each offer extended to a prospect is determined. The relative value of each offer may be based on a variety of factors. For example, the relative value of an offer may be based on the past performance records of the school extending the offer. In some embodiments, a numerical representation of the school's past performance is derived using the Elo rating system. In an Elo rating system, rating is represented by a number, which increases or decreases based upon the outcome of games between rated players. After every game, the winning side takes points from the losing side. The total number of points gained or lost after a game is determined by the difference between the ratings of the winner and loser. In college football, for example, the outcomes of intercollegiate games in each school year may be used to determine the school's Elo score for that year. In some embodiments, the Elo rating from multiple years can be included in the calculation of the relative value. For example, the relative value associated with a school may be a weighted average of Elo rating scores from the previous three years. The Elo score from one year ago may count for half of the weighted average, the Elo score from two years ago may count for one-third of the weighted average, and an Elo score from three years ago may count for one-sixth of the weighted average. In some embodiments, the relative value of a school may be based on one, two, four, five, or more years of Elo scores.

In some embodiments, the relative value of an offer may be based on one or more other factors including offer amount, offer timing, and/or a school's conference ranking, tournament placement, team revenue, academic ranking, estimated fan base for sports teams, net earning of a company, etc. The relative value may also be based on published ranking of the organization such as university rankings or corporate rankings that are published by different magazines and newspapers. The relative value may generally be any quantifiable and comparable characteristics of an organization.

In some embodiments, the relative values associated with schools are calculated and stored prior to the process shown in FIG. 3. Step 303 may include reading the relative values associated with each school that extended an offer to a prospect from a look-up table. The relative values table may be stored in a local, external, remote, and/or networked computer readable medium.

In step 305, relative values for each offer extended to a prospect are added to generate the prospect's offer points score. For example, if prospect A receives offers from schools X, Y, and Z, the relative values associated with schools X, Y, and Z are added together to generate prospect A's offer points score.

In some embodiments, after the offer points associated with each offer a prospect received is added, the sum of the offer points may be adjusted with other factors to derive an offer points score. For example, offer point scores may be adjusted based on the timing when the prospect commit to an organization. In college football for example, this may be associated with the length of time between the date a player accepts an offer and the signing day (last date to commit to a school). Once a prospect commits to an organization, the number offers they will receive is likely to be reduced because other organization are less inclined to make offers to a player who has already committed to another organization. This adjustment would compensate players who commit early to adjust for those offers they likely lost due to early commitment. Another factor that may be used to adjust offer points scores may be based on the prospect's specialization. In college football for example, a player's final offer points score may be adjusted base on their position (quarter back, running back, etc.). Offer points score may also be adjusted based on other characters such as their origin state, city, high school, GPA, etc.

In step 307, whether more prospects should be rated is determined. If more prospects need to be rated, the process returns back to step 301. If all the ratings are completed, the process proceeds to step 309. The list of prospects to be rated may be based on information from one or more internal or external databases. In some embodiments, the list of prospects is retrieved from one or more databases of offer data. Offer data may include a listing of offers, each offer being made from a school to a prospect. In step 307, the offer points scores of one or more prospects may be stored in a computer readable medium for subsequent retrieval and utilization.

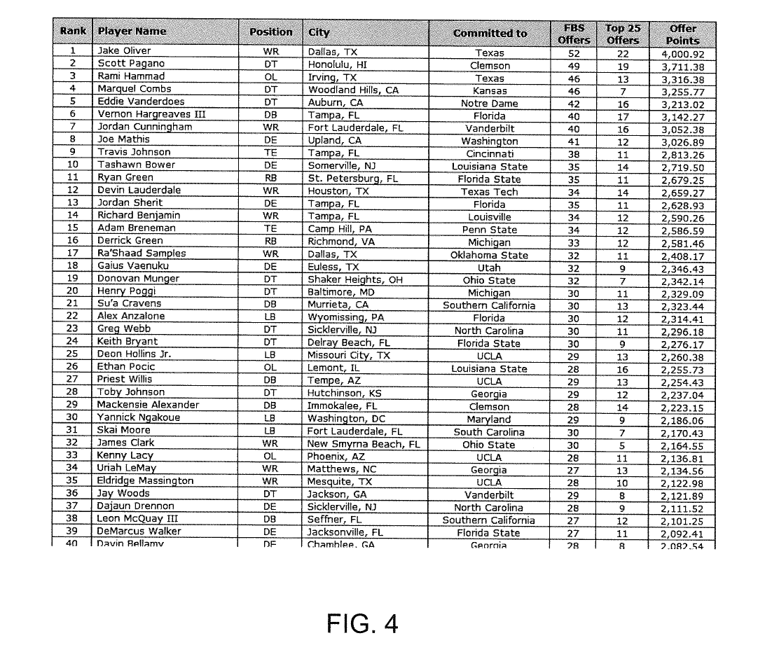

In step 309, prospects are ranked based on their offer points scores as determined in step 305. In some embodiments, prospects with higher offer points scores receive a higher ranking. While steps 303-305 may be used to determine the offer points score for prospects from different school years and different specialties, prospects may be ranked according to their respective school year and specialty. Step 309 may include displaying the ranking of the prospects. The display of the ranking may include other information such as prospect position, prospect city of origin, prospect school commitment, number of offers received, and offer points scores associated with the prospect. The display of the ranking may further allow the user to interact with the ranking. For example, the user may search, sort, and filter the ranking. An example of a displayed prospect ranking is described herein with reference to FIG. 4 below.

In some embodiments, step 309 may be optional to the process shown in FIG. 3. The information stored after the completion of step 307 may be used for other purposes such as to generate a rating of an origin entity such as a school, state, city etc. For example, offer points scores of all prospects associated with an origin school, state, or city may be added together to generate the offer points scores for that origin school, state, or city. If the recruiting period is completed and prospects have confirmed their attendance to recruiting schools, the information stored at the completion of step 307 may also be used to rank the recruiting schools. For example, if prospects A, B, and C have committed to school X, the offer points of prospects A, B, and C may be added together to generate school X's offer points score. A ranking of schools may be determined based upon each school's offer points score.

In some embodiments, the system is configured to automatically repeat steps 301 to 307 and update the stored prospect offer points scores when offer data is updated.

The method shown in FIG. 3 may be performed by one or more processor-based devices such as a personal computer, a server, a mobile device, etc., as described above in FIGS. 1, 2. The resulting rating and/or ranking may be displayed on a display screen that may be integrated, local, networked, and/or remote from the processor-based device. The process can also be performed by multiple software or hardware modules. For example, an offer aggregating module may perform step 301, a relative value determining module may perform step 303, a prospect offer points scores calculating module may perform step 305, and a prospect ranking module may perform step 309. The modules can each be executed on one or more processor-based devices, and some of the above modules may be combined into one software or hardware module. In some embodiments, one or more of steps 301-309 may be performed manually, with a processor-based device, or with a combination of the two.

Referring next to FIG. 4, a display screen showing a ranking of prospects according to some embodiments is shown. The table shown in FIG. 4 is a specific example of an offer-based ranking of high school football players. Rankings of other types of prospects may be similarly displayed. The table in FIG. 4 includes the columns “Rank,” “Player Name,” “Position,” “City,” “Committed to,” “FBS offers,” “Top 25 offers,” and “Offer points.” In this particular case, the players have already committed to one school for enrollment. The “position” column lists the player's position on his/her high school football team. The “city” column lists the player's city of origin. The “Committed to” column lists the college that the player is committed to attend. The “FBS offers” column lists the total number of Football Bowl Subdivision (Division I-A) schools that had made an offer to the player. The “Top 25 offers” column lists the total number of Top 25 schools that had made an offer to the player. The “offer points” column lists the offer points scores of each player. In some embodiments, the number listed in the “offer points” column is calculated according to the method described with reference to FIG. 3 above.

A similar rankings table may be generated for athletes in other sports and other types of prospects. Rankings for colleges, cities, and high schools, may also be similarly displayed. For example, a school offer points score for Texas may be calculated by adding the offer points scores for Jake Oliver, Rami Hammand, and other players that have committed to attending Texas. In some embodiments, the user viewing the rankings table may sort the table by selecting a column of the table. In some embodiments, the user can filter and search the entries in the table. For example, the user may select to only view the rankings of players who have committed to Texas, only players from Dallas, Tex., etc.

It is understood that the data in FIG. 4 is shown as an illustrative example only. The information in the table is determined based on one embodiment of the present disclosure. Different offer points and ranking may result from other embodiments of the present disclosure. Other embodiments of the present disclosure may also display more or less information on the rankings table.

Many of the functional units described in this disclosure have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. An apparatus for generating prospect rating, comprising:
a non-transitory storage medium; and
a processor configured to execute computer-readable codes stored on the non-transitory storage medium to perform the steps of:
determine one or more offers that have been extended to a prospect;
determine a relative value for each of the one or more offers based on an organization associated with the offer;
add relative values of each of the one or more offers extended to the prospect to generate a prospect offer points score; and
store, in a storage device, prospect offer points scores associated with a plurality of prospects.

2. The apparatus for generating prospect rating of claim 1, wherein the processor is further configured to perform the step of:
generate a ranking of the plurality of prospects based on prospect offer points scores of each of the plurality of prospects for display on a display device.

3. The apparatus for generating prospect ranking of claim 2, wherein the generate of the ranking of plurality of prospects for display step further comprises providing at least one of prospect position, prospect city of origin, prospect organization commitment, number of offers received, and offer points scores for display on the display device.

4. The apparatus for generating prospect ranking of claim 2, wherein the plurality of prospects comprises prospects in a same graduating year.

5. The apparatus for generating prospect ranking of claim 2,
wherein the ranking of the plurality of prospects is automatically updated when offer data is updated.

6. The apparatus for generating prospect rating of claim 1, wherein the relative value of an offer is determined based on past performance record of the organization extending the offer.

7. The apparatus for generating prospect rating of claim 1, wherein the relative value of an offer is determined based on at least an Elo rating score of a prior performance the organization associated with the offer.

8. The apparatus for generating prospect rating of claim 1,
wherein the relative value of an offer is determined based on a weighted average of previous three years of Elo rating score of the organization associated with the offer; and
wherein an Elo score from one year ago counts for half of the weighted average, an Elo score from two years ago counts for one-third of the weighted average, and an Elo score from three years ago counts for one-sixth of the weighted average.

9. The apparatus for generating prospect rating of claim 1,
wherein the relative value of an offer is determined by retrieving the relative value from a look-up table comprising relative values associated with a plurality of organizations.

10. The apparatus for generating prospect rating of claim 1, wherein the determine one or more offers that have been extended to the prospect step comprises combining data from two or more databases.

11. The apparatus for generating prospect rating of claim 1, wherein the processor is further configured to perform the steps of:
add prospect offer points scores for one or more prospects who have committed to join an organization to generate an organization offer points score; and
generate a ranking of a plurality of organizations based on organization offer points scores of each of the plurality of organizations.

12. The apparatus for generating prospect rating of claim 1, wherein the prospect comprises an athlete and the organization comprises a school.

13. The apparatus for generating prospect rating of claim 1, wherein an origin entity offer points score is generated by adding the prospect offer points scores of prospects associated with an origin entity;
wherein the origin entity comprises one or more of a high school, a city, and a state.

14. A computer-implemented method for generating prospect rating, comprising:
determining one or more offers that have been extended to a prospect;
determining a relative value for each of the one or more offers based on an organization associated with the offer;
adding relative values of each of the one or more offers extended to the prospect to generate a prospect offer points score; and
storing, in a non-transitory computer readable medium, prospect offer points scores associated with a plurality of prospects.

15. The computer-implemented method of claim 14, further comprising:
generating a ranking of the plurality of prospects based on prospect offer points scores of each of the plurality of prospects for display on a display device.

16. The computer-implemented method of claim 15, wherein the generating of the ranking of plurality of prospects for display further comprises providing at least one of prospect position, prospect city of origin, prospect organization commitment, number of offers received, and offer points score for display on the display device.

17. The computer-implemented method of claim 15, wherein the plurality of prospects comprises prospects in a same graduating year.

18. The computer-implemented method of claim 15, wherein the ranking of the plurality of prospects is automatically updated when offer data is updated.

19. The computer-implemented method of claim 14, wherein the relative value of an offer is determined based on past performance record of the organization associated with the offer.

20. The computer-implemented method of claim 14, wherein the relative value of an offer is determined based on at least an Elo rating score of a prior performance the organization associated with the offer.

21. The computer-implemented method of claim 14,
wherein the relative value of an offer is determined based on a weighted average of previous three years of Elo rating score of the organization associated with the offer; and
wherein an Elo score from one year ago counts for half of the weighted average, an Elo score from two years ago counts for one-third of the weighted average, and an Elo score from three years ago counts for one-sixth of the weighted average.

22. The computer-implemented method of claim 14, wherein the relative value of an offer is determined by retrieving the relative value from a look-up table comprising relative values associated with a plurality of organizations.

23. The computer-implemented method of claim 14, wherein the determining one or more offers that have been extended to the prospect comprises combining data from two or more databases.

24. The computer-implemented method of claim 14, further comprising:
adding prospect offer points scores for one or more prospects who have committed to join an organization to generate an organization offer points score; and
generating a ranking of a plurality of organizations based on organization offer points scores of each of the plurality of organizations.

25. The computer-implemented method of claim 14, wherein the prospect comprises an athlete and the organization comprises a school.

26. The computer-implemented method of claim 14, wherein an origin entity offer points score is generated by adding prospect points scores of prospects associated with an origin entity;
wherein the origin entity comprises one or more of a high school, a college, a city, and a state.

27. A computer-implemented method for generating prospect rating, comprising:
retrieving from one or more databases, information on a plurality of offers, each of the plurality of offers being made from an organization to a prospect;
for a plurality of prospects, retrieving from a look-up table, the relative value for one or more offers extended to each of the plurality of prospects; and
adding, with a computer processor, relative values of the one or more offers extended to the prospect to generate a prospect offer points score; and
storing, in a non-transitory computer readable medium, prospect offer points scores associated with the plurality of prospects;
wherein the relative value for an offer extended by an organization is based on a weighted average of Elo scores of the organization's performance from two or more prior years.

28. The computer-implemented method of claim 27, further comprising:
ranking the plurality of prospects based on prospect offer points score of each of the plurality of prospects.
